(19) United States
(12) Patent Application Publication
(10) Pub. No.: US 2025/0078682 A1
(43) Pub. Date: Mar. 6, 2025

(54) DISTANCE LEARNING SIMULATION SYSTEMS AND METHODS

(71) Applicant: University of South Florida, Tampa, FL (US)

(72) Inventors: Jamie Ann Toghranegar, Odessa, FL (US); Howard Kaplan, Tampa, FL (US)

(21) Appl. No.: 18/823,161

(22) Filed: Sep. 3, 2024

Related U.S. Application Data
(60) Provisional application No. 63/580,255, filed on Sep. 1, 2023.

(51) Int. Cl. G09B 23/28; G09B 23/30

(52) U.S. Cl. CPC G09B 23/286; G09B 23/285; G09B 23/30

(57) ABSTRACT

An example system includes an anatomical model; a camera configured to image the anatomical model; an instrument; a controller operably coupled to the camera and the instrument, the controller comprising a processor and a memory, the memory having computer-executable instructions stored thereon that, when executed by the processor, cause the controller to: receive an image from the camera; determine, based on the image, a position of the instrument relative to the anatomic model; display a simulated image of an anatomical structure based on the position of the instrument relative to the anatomical model. An example method includes simulating a procedure by receiving an image from a camera; determining a position of an instrument relative to an anatomical model based on the image; and displaying a corresponding anatomical image from an imaging procedure based on the position of the instrument relative to the anatomical model.

### CROSS-REFERENCE TO RELATED APPLICATIONS

This application claims the benefit of U.S. provisional patent application No. 63/580,255, filed on Sep. 1, 2023, and titled “ADEPT Simulator: AI-Enhanced Distance-Learning Endoscopic Performance Training Simulator,” the disclosure of which is expressly incorporated herein by reference in its entirety.

### BACKGROUND

Simulators are commonly used in medical training. Such simulators often include a model of a part of a patient's anatomy, including relevant anatomical features to the procedure being simulated. Additionally, the features of the simulator can be tailored to the types of procedure that the simulator is used to train. As a result, simulators vary in complexity, can include complex anatomical models. Improvements to simulators, in particular improvements to medical simulators, can improve medical training.

### SUMMARY

Systems and methods for simulating medical procedures are described herein.

In some aspects, implementations of the present disclosure include a system including: an anatomical model; a camera configured to image the anatomical model; an instrument; a controller operably coupled to the camera and the instrument, the controller including a processor and a memory, the memory having computer-executable instructions stored thereon that, when executed by the processor, cause the controller to: receive an image from the camera; determine, based on the image, a position of the instrument relative to the anatomic model; display a simulated image of an anatomical structure based on the position of the instrument relative to the anatomical model.

In some aspects, implementations of the present disclosure include a system, wherein the anatomical model includes a marker, and wherein determining the position of the imaging instrument includes determining the position of the imaging instrument relative to the marker.

In some aspects, implementations of the present disclosure include a system, wherein the marker includes a binary identifier.

In some aspects, implementations of the present disclosure include a system, wherein the anatomic model includes a model of an esophagus.

In some aspects, implementations of the present disclosure include a system, wherein the instrument includes an endoscope.

In some aspects, implementations of the present disclosure include a system, wherein the instrument includes a model of a laparoscopic instrument.

In some aspects, implementations of the present disclosure include a system, wherein the instrument includes a model of an endoscope.

In some aspects, implementations of the present disclosure include a system, wherein the instrument includes an instrument marker.

In some aspects, implementations of the present disclosure include a system, wherein the memory has further computer-executable instructions stored thereon that, when executed by the processor, cause the controller to: determine an orientation of the instrument relative to the anatomic model, and wherein the simulated image of the anatomical structure is based on the position and orientation of the instrument relative to the anatomical model.

In some aspects, implementations of the present disclosure include a system, wherein displaying a simulated image of an anatomical structure includes displaying a frame of a video of a non-simulated procedure.

In some aspects, implementations of the present disclosure include a system, wherein the video of the non-simulated procedure includes a plurality of frames, and wherein each of the plurality of frames is annotated with a position of the frame in the non-simulated procedure.

In some aspects, implementations of the present disclosure include a system wherein the memory has further computer-executable instructions stored thereon that, when executed by the processor, cause the controller to: display an instruction to position the instrument at a predetermined location relative to the anatomical model.

In some aspects, implementations of the present disclosure include a system wherein the memory has further computer-executable instructions stored thereon that, when executed by the processor, cause the controller to: detect that the instrument is positioned at the predetermined location of the anatomical model.

In some aspects, implementations of the present disclosure include a system, further including: displaying an indication that the instrument is positioned at the predetermined location of the anatomical model.

In some aspects, implementations of the present disclosure include a computer-implemented method of simulating a procedure, including: receiving an image from the camera; determining a position of an instrument relative to an anatomical model based on the image; and displaying a corresponding anatomical image from an imaging procedure based on the position of the instrument relative to the anatomical model.

In some aspects, implementations of the present disclosure include a computer-implemented method, wherein displaying the corresponding anatomical image from the imaging procedure includes: receiving a plurality of annotated images from the imaging procedure; and selecting, from the plurality of annotated images, an image corresponding to a patient anatomy at the position of the instrument in the anatomical model.

In some aspects, implementations of the present disclosure include a computer-implemented method, further including: displaying an instruction to position the instrument at a predetermined location relative to the anatomical model.

In some aspects, implementations of the present disclosure include a computer-implemented method, further including: detecting that the instrument is positioned at the predetermined location of the anatomical model.

In some aspects, implementations of the present disclosure include a computer-implemented method, further including: displaying an indication that the instrument is positioned at the predetermined location of the anatomical model.

In some aspects, implementations of the present disclosure include a computer-implemented method, further including determining a velocity of the instrument relative to the anatomical model, and wherein displaying the corresponding anatomical image from the imaging procedure is based on both the position and velocity of the instrument relative to the anatomical model.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a system for providing a simulated image of an anatomical structure, according to implementations of the present disclosure.

FIG. 2A illustrates an example anatomical model including markers, an instrument, and an instrument marker, according to implementations of the present disclosure.

FIG. 2B illustrates an example system configured to simulate a medical procedure using the anatomical model of FIG. 2A.

FIG. 3A illustrates an example system configured to simulate a medical procedure using an anatomical model, according to implementations of the present disclosure.

FIG. 3B illustrates an example system configured to simulate a medical procedure using an anatomical model, according to implementations of the present disclosure.

FIG. 4 illustrates an example computer implemented method of simulating a medical procedure based on tracking the position of an instrument relative to an anatomical model, according to implementations of the present disclosure.

FIG. 5A illustrates conventional anatomical models.

FIG. 5B illustrates an example 3D printed anatomical model according to implementations of the present disclosure.

FIG. 6 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for endoscope simulation, it will become evident to those skilled in the art that the implementations are not limited thereto, but are applicable for other types of simulation.

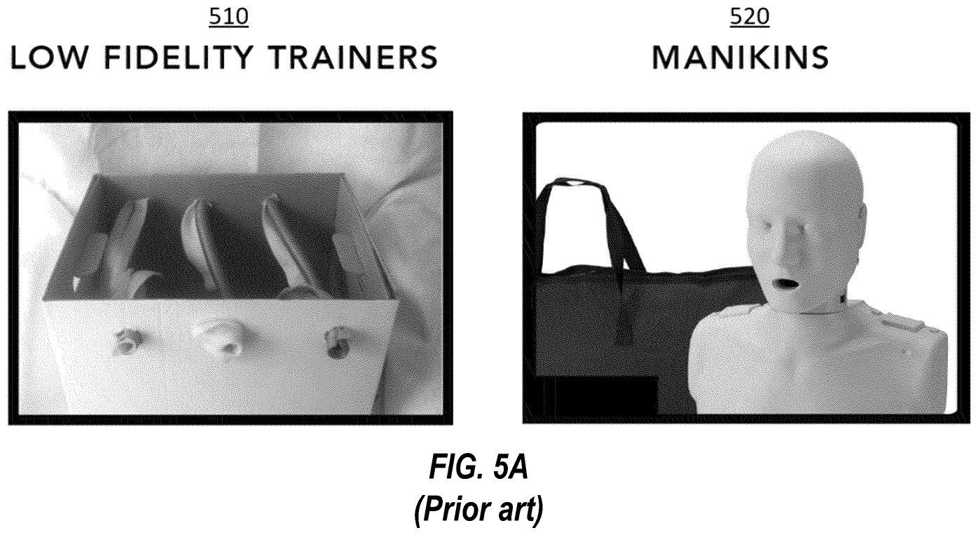

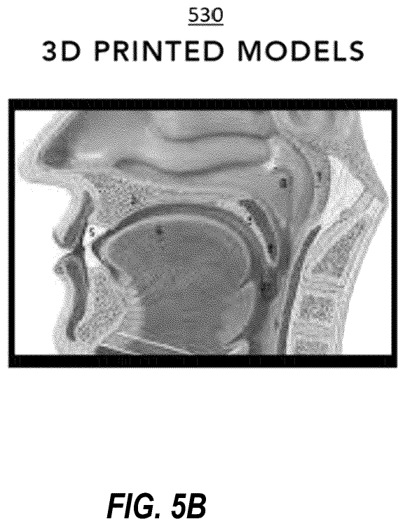

Medical procedures can require specialized training to perform. Thus, simplified (“low fidelity”) training systems are often insufficient for preparing practitioners for clinical practice. Conversely, real-world training can be impractical (e.g., because real patients in a clinical setting may not consent to being part of a training procedure). Alternatives to training in a clinical setting include realistic models and cadavers. But the use of realistic models is limited by the complexity, size, and expense of such models. Similarly, cadavers can be used for types of training, but require specialized storage and pose other challenges. Accordingly, a significant limitation of medical training is access to realistic training materials, including training materials that can be realistically provided to students for use outside of specialized training facilities (e.g., at home or in ordinary classrooms). FIG. 5A illustrates example prior art training systems. The low-fidelity trainer 510 shown in FIG. 5A illustrates the limitations of such simple models, lacking a realistic anatomical representation. The manikin 520 includes more accurate simulated anatomy than the low-fidelity trainer 510, but requires more material, cost, and complexity that present barriers to using in routine training.

FIG. 5B illustrates an example of a complex model 530 created in a study of an example implementation of the present disclosure that can accurately simulate complex anatomy of the portion represented.

Described herein are systems and methods for providing realistic simulations of procedures without the use of complicated models. The systems and methods of the present disclosure include systems that use a display to show realistic videos/images of a real procedure, while a simplified model of an instrument and/or simplified model of a patient is used to perform the simulated procedure. Thus, the realistic videos/images can deliver a realistic training experience, without requiring realistic models and/or real patients/cadavers. The systems and methods described herein can allow for accessible and/or mobile training kits that can be used outside of conventional training environments (e.g., in a home or office).

For example, implementations of the present disclosure can be configured to perform training on endoscope procedures. Endoscope procedures use a camera or fiber optic inserted into the mouth of a patient to diagnose various conditions by visually inspecting the patient. In particular, the endoscope user may desire to view specific parts of a patient (e.g., structures in the pharynx/larynx) to diagnose specific conditions. Thus, the endoscope user benefits from being able to accurately position/insert the endoscope into a patient. The manipulation of an endoscope is a skill that can be improved by repeated practice.

One type of endoscope procedure is a “FEES” test (Fiberoptic endoscopic evaluation of swallowing). FEES tests can be used to assess/diagnose the structure of the pharynx and larynx, and evaluate how a patient swallows both with and without food. For example, individuals with dysphagia (difficulty swallowing or a swallowing impairment) can benefit from a FEES test to determine the cause of the dysphagia and/or provide recommendations to treat/mitigate the dysphagia. Dysphagia has different causes, which can include injuries, cancer, and/or muscle coordination, as examples. Determining the cause of dysphagia can be an important part of providing effective treatment for dysphagia.

In training to perform a FEES test, practitioners are assessed on their ability to manipulate an endoscope. For example, the practitioner can be required to manipulate the endoscope within a patient's hypopharynx to obtain a desired view of the patient's anatomy. Once the endoscope is correctly positioned in a FEES test, the practitioner can be required to perform various assessments, including, for example: (a) assessing vocal fold mobility and laryngeal closure for phonation, breath holding, and cough; (b) assessing secretion management, quantity and location of pharyngeal residue, pharyngeal constriction/contraction symmetry, and swallow initiation; (c) presenting various bolus consistencies, dyed green for contrast, based on clinical assessment; and (d) determining presence, amount, and timing of any laryngeal penetration and/or aspiration, noting if silent vs. audible and protective vs. unprotective. Thus, training the practitioner to manipulate the endoscope and/or identify features of the patient from the endoscope view can be useful training for performing a FEES exam.

Other procedures (e.g., endoscope procedures, laparoscopy procedures) also require the skill of both properly positioning an instrument and identifying the anatomy around the instrument using a camera/fiber-optic. Thus, it will be understood by one of skill in the art that the systems and methods described herein can be used to perform any kind of training with any kind of instrument/anatomy, and that the specific endoscope procedures described herein are provided only as an example. For example, the techniques described herein can be used to train for laparoscopy procedures by training a user to correctly position a fiber optic/camera used in the laparoscopy procedure, and/or identify the anatomy that is being treated in a laparoscopy procedure.

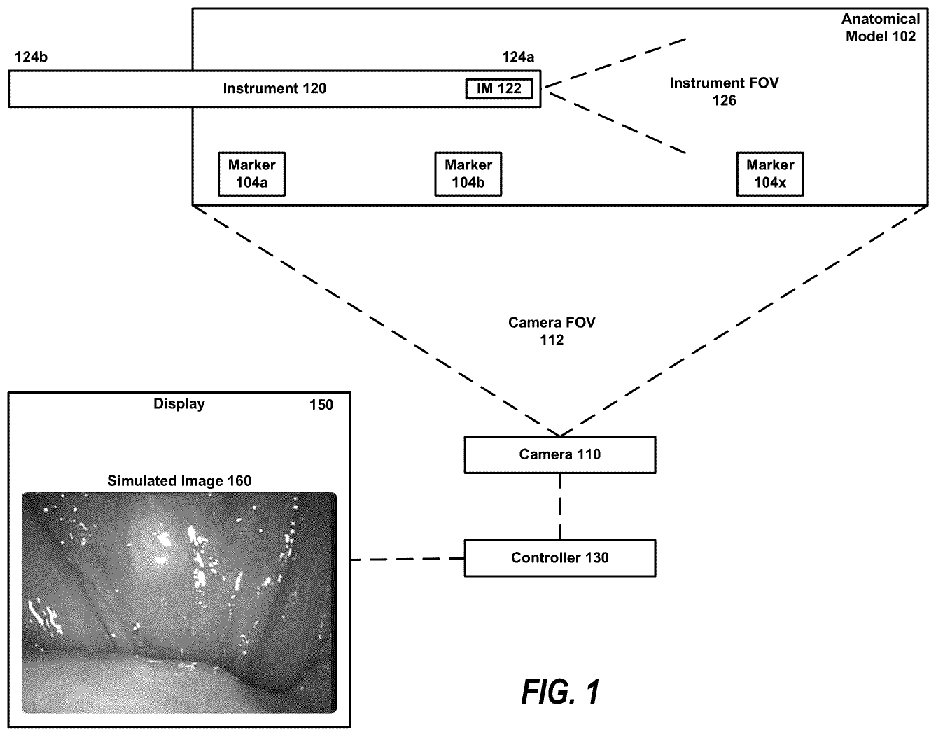

With reference to FIG. 1, an example system is shown according to implementations of the present disclosure. The system includes an anatomical model 102. The anatomical model 102 can include any portion of a patient's anatomy. As non-limiting examples, the anatomical model 102 can include any or all of all of a patient's throat. The anatomical model 102 can be a model that realistically represents the proportions and shape of a patient's anatomy, but that is simplified (e.g., it may not include realistic colors, may not include realistic feeling materials and/or may include simplified shapes/geometry). For example, the anatomical model 102 can be created as a single piece of soft plastic (e.g., TPU) that is 3D-printed. The anatomical model 102 described herein can simulate the size/shape of a patient, without including a complex/detailed model.

The anatomical model 102 includes one or more markers 104a, 104b, 104x placed on the anatomical model 102. While three markers 104a, 104b, 104x are shown, it should be understood that any number of markers 104a, 104b, 104x can be used. As used herein, the markers 104a, 104b, 104x can be any identifiable feature. For example, markers can include colored material (e.g., tapes or paints), materials with geometric shapes (e.g., dots or X's), and/or any other feature or combination of features that make the markers 104a, 104b, 104x identifiable. Optionally, the markers 104a, 104b, 104x are configured to be identified/tracked by computer vision systems as described herein (e.g., using a camera and controller to capture an image and identify the marker(s) in the image). It should be understood that the markers 104a, 104b, 104x can be in different positions and orientations relative to each other, and that the positions and orientations of the markers described throughout the present disclosure are intended only as non-limiting examples.

The system includes a camera 110 with a camera field of view 112. The camera field of view 112 is defined as the area that is imaged by the camera 110. The camera field of view 112 can be configured so that it includes any or all of the markers 104a, 104b, 104x is imaged by the camera 110. Optionally, the camera 110 can be in a known position and/or orientation relative to the anatomical model 102. For example, the camera 110 can be positioned at a predetermined distance from the anatomical model 102.

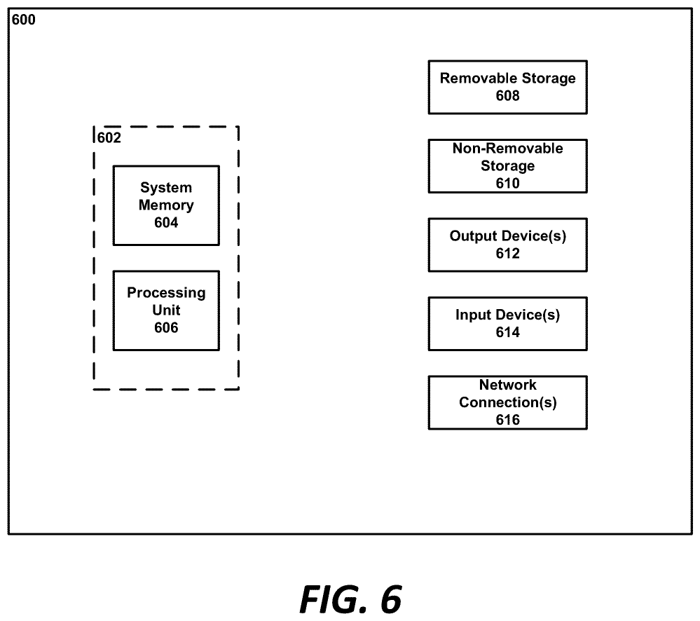

The camera 110 can be in communication with a controller 130 (e.g., by wired, wireless, or other communication network). Both the camera 110 and/or controller 130 can include any or all of the components of the computing device 600 shown and described with reference to FIG. 6. Additionally, it should be understood that the camera 110 can be a video and/or still camera, and that different frame rates of video/still images can be used in implementations of the present disclosure.

Still with reference to FIG. 1, the system can include an instrument 120. The instrument 120 can be a functioning instrument (e.g., an endoscope), and/or a model instrument (e.g., a plastic housing in the shape of an endoscope). As additional examples, the instrument 120 can be a laparoscopic surgery instrument (e.g., a lighted tube with a video camera or fiber optic), and/or a model of a laparoscopic surgery instrument (e.g., a tube with approximately the size and shape of a laparoscopic surgery instrument). Again, the endoscope and laparoscopy instruments described herein are only non-limiting examples, and any instrument or model of an instrument can be used as the instrument 120 shown in FIG. 1.

The instrument 120 can include one or more instrument markers 122. Optionally, as shown in FIG. 1, the instrument marker can be at a distal end 124a of the instrument 120, while the proximal end 124b of the instrument 120 can be the end configured to be manipulated by the user. In a conventional endoscope, the distal end of the endoscope is generally the part of the endoscope configured to image the patient (e.g., by a camera or fiber optic positioned at the distal end of the endoscope). Thus, by placing the instrument marker 122 at the distal end 124a of the instrument 120, the instrument marker 122 can be used to track the position of the part of the instrument 120 that would be configured to perform imaging in a real procedure (whether the instrument is a real instrument or a model of a real instrument).

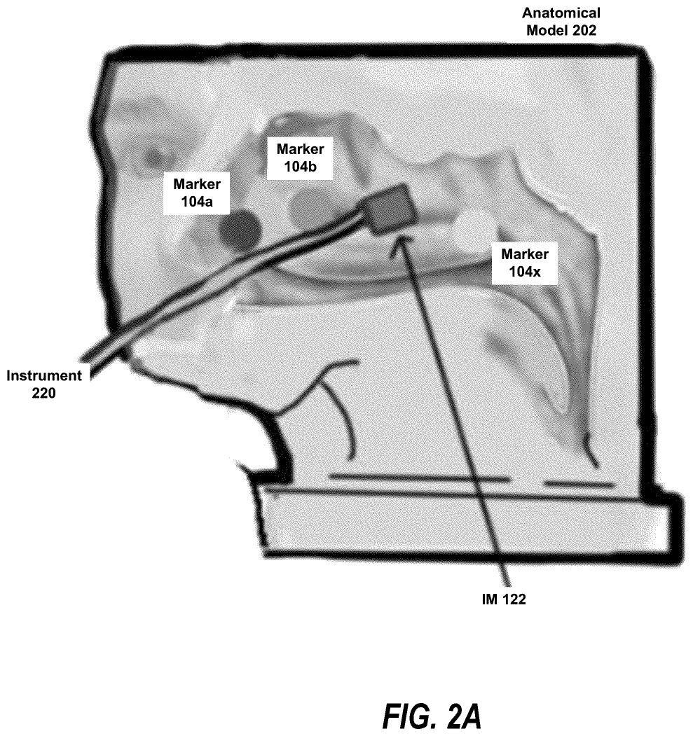

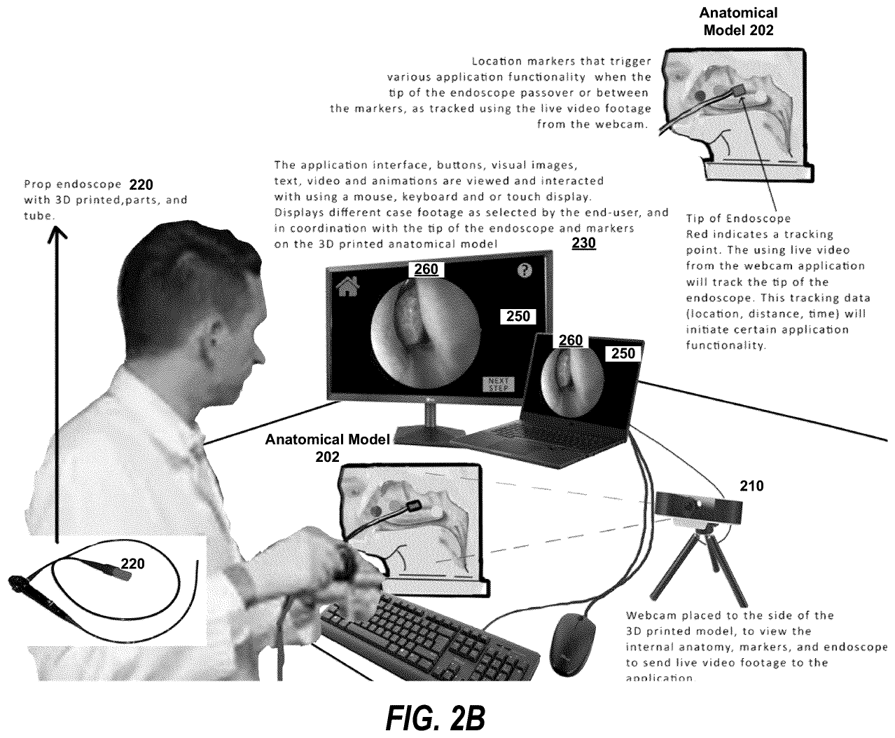

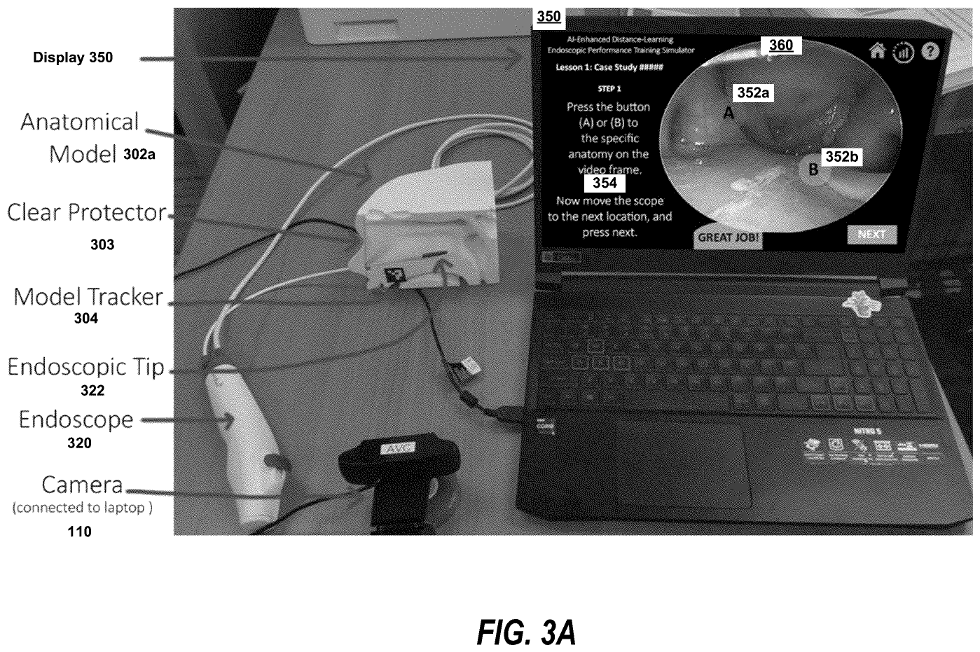

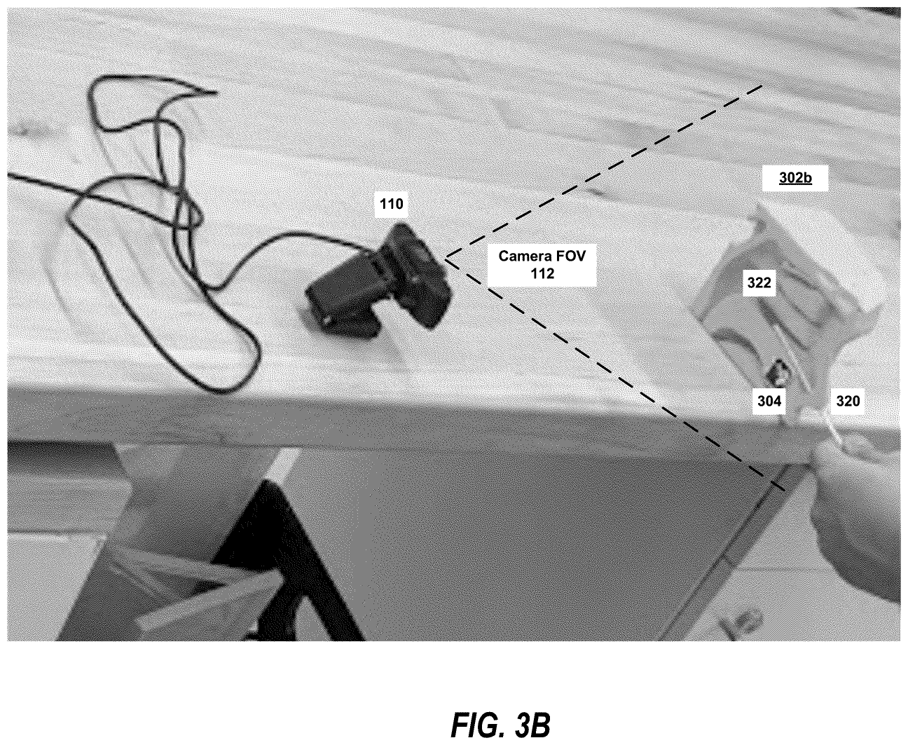

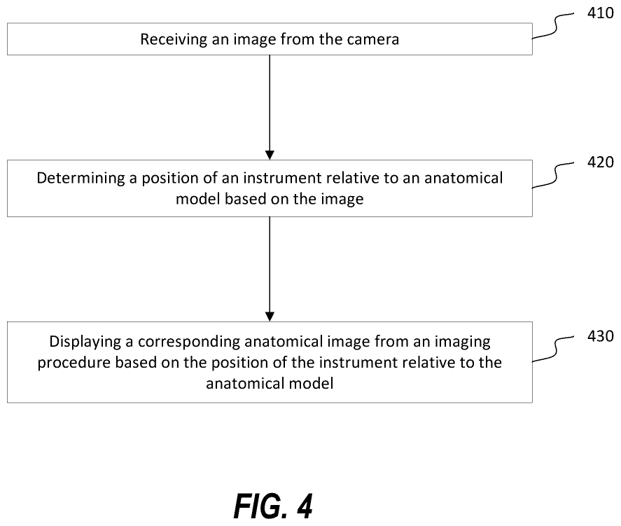

As also shown in FIG. 1, the instrument can define an instrument field of view 126 that represents the part of the anatomical model 102 that would be imaged by the instrument 120, if the instrument 120 included a camera (e.g., if the instrument were a real endoscope). The instrument field of view 126 can optionally be used by the controller 130 to determine the simulated view displayed to the user, as described below with reference to the example displays shown in FIGS. 2B, and 3A, as well as the method of FIG. 4, for example.

The controller 130 can be configured to track the location of the instrument marker 122 relative to the markers 104a, 104b, 104x. and thereby determine the position and/or orientation of the instrument 120 relative to the anatomical model 102.

As shown in FIG. 1, a display 150 can be operably coupled to the controller 130 (e.g., by wired or wireless network). As described with reference to FIG. 6, optionally the display 150 can be implemented by the computing device 600 (for example as an output device 612 of the computing device 600). In some implementations, both the display 150 and controller 130 can be implemented using the same computing device (e.g., using a laptop, tablet, or other mobile computing device).

The display 150 can be configured to show a simulated image 160 based on the location of the instrument 120. For example, the display 150 can be configured to display the view that would be seen if the instrument 120 in the anatomical model 102 were an endoscope inside a person. Example methods for determining the simulated image 160 to show and/or determining the location of the instrument 120 relative to the anatomical model 102 are further described with reference to FIG. 4.

Optionally, the controller 130 can be configured to receive and/or store a set of annotated images in memory (e.g., the system memory 604, removable storage 608, and/or non-removable storage 610 of the computing device 600). The annotated images can be from an imaging procedure that was performed on a real patient (e.g., showing the anatomy of that was be seen by an endoscope or other imaging device in a procedure). The annotated images can include both images and annotations that describe the position and/or orientation of the imaging device when the image was captured in a real patient. For example, an image from an endoscope in a real procedure can be annotated indicating that it is an image of a particular part of the patient's anatomy, and/or was an image was captured at a known position/orientation in the patient.

Using the annotated images, the controller 130 can be configured to compare the position and/or orientation of the instrument determined at step 420 shown in FIG. 4 to the annotations of the annotated images, and thereby select an annotated image for display. For example, if the controller 130 determines that the instrument is about 10 cm into the anatomical model 102, the controller can select an annotated image that corresponds to the view of an endoscope about 10 cm into a real patient. As an additional example, the controller 130 can determine a position/orientation of the instrument 120 relative to the anatomical model 102 and select an annotated image captured by an endoscope closest to that position/orientation in a real patient.

As a non-limiting example, selecting an annotated image that is closest to the position/orientation in a real patient can include: (1) receiving a camera image; (2) flipping the camera image; (3) creating a grayscale image from the camera image; (4) identifying the marker and determining the size of the marker; (5) identifying a region of interest around the marker (e.g., a region that covers the anatomical model); and (6) determining an expected progress value of the endoscope based on the position of the marker within the region of interest. For example, the progress can be calculated as: progress=frame_count−(EndoscopeX/(ROI[1][0]−ROI[0][0])*frame_count). Where ROI[1][0]−ROI[0][0] gets the current width of the ROI and frame_count is the number of frames in the “RealImages” folder (e.g.,, where the images of the real patient/procedure are stored).

After progress is determined, the method can include clamping the result between 0 and frame_count (total frames in that sequence/video). Finally, the method can include using the progress of the endoscope through the anatomical model to select a frame of the real video corresponding to an endoscopoe image at a same or similar amount of progress through the real patient.

As a non-limiting example, position/orientation can be tracked relative to the camera 110 with a marker on the model. The camera 110 can optionally be configured so that the entire anatomical model 102 is in view (e.g., if the model is a model head, then the entire head model is in view of the camera). The camera field of view 112 can optionally be configured to capture the side/sagittal view. Tracking can include checking to see if the color of the endoscope tip is with in the boundary of the anatomical model, and then determining the position/orientation. The boundary of the anatomical model can be set relative to the local screen size of the marker as seen by the camera.

Alternatively or additionally, the controller 130 can be configured to receive and/or store annotated video segments in memory. The annotations of the annotated video segments can include information about the speed, position and/or orientation of the endoscope used to record the annotated videos. The controller 130 can be configured to estimate the velocity of the instrument 120 using the instrument marker 122. Based on the velocity of the instrument 120 relative to the anatomical model 102, the controller 130 can be configured to play back a video clip from the perspective of an endoscope moving at the estimated velocity relative to the patient's anatomy.

For example, if the example implementation is configured to simulate an endoscope inserted into a nostril, the videos can start at the nostril, since that can be the entry point for the anatomical model. As the tip of the endoscope is tracked the position is calculated with mark located on the model, and the corresponding video frame is displayed (the video plays forward or backward through the frames). Orientation can use the position and frame to load the corresponding frame (up, down, rotating left or right) since the position is known. know the position. Thus, the video frames can be switched between based on the position/orientation of the tip of the endoscope that is tracked.

As another example, the videos can be preloaded patient case procedure video's image sequence, or frames. These are videos that are recorded from a real endoscope from multiple orientations. These videos/frames are saved in the system, and can be used in a training module that the user chooses when using the application/system.

Optionally, the controller can be configured to further select a video with a corresponding position/orientation as the instrument 120. For example, if the instrument 120 is moving at 1 cm/second into the pharynx/larynx of a patient, the video can be a video captured from the perspective of an endoscope entering a pharynx/larynx of a patient at 1 cm/second. The controller 130 can then select, from the annotated videos, a video that most accurately matches the position, orientation and/or speed of the instrument 120 estimated by the controller. Optionally, the controller can speed up or slow down the rate of video playback to synchronize the video playback with the movement of the instrument 120.

As a non-limiting example, the camera can capture 1 frame per 70 milliseconds, calculate position and distance, and then use those values to select a corresponding video frame image from the actual procedure. It should be understood that the markers described herein can vary in number and/or type. For example, the markers can have any color and/or shape (e.g., colors and/or shapes that contrast with the model). It should also be understood that the marker can be a marker including a binary matrix or other identifier.

Studies were performed on implementations of the system shown in FIG. 1. FIGS. 2A-3B illustrate example configurations of the system shown in FIG. 1 configured for training users in an endoscopy procedure.

FIG. 2A illustrates a side-view of an anatomical model 202 of the pharynx and larynx. The anatomical model 202 includes three markers 104a, 104b, 104x as described with reference to FIG. 1. An endoscope 220 is shown positioned in the structure of the pharynx/larynx, where the instrument marker 122 on the example instrument.

FIG. 2B illustrates a system including the anatomical model 202 of FIG. 2A. The system shown in FIG. 2B is configured for operation with a prop endoscope 220 that was printed using 3D printed parts and a tube. A webcam 210 is configured to view the anatomical model 202, and operably connected to a computing device 230 that acts as a controller. As shown in FIG. 2B, the computing device 230 can optionally be a mobile computing device and can include any or all of the components of the computing device 600 described with reference to FIG. 6. A display 250 of the computing device displays a simulated image 260 (e.g., an image of an actual patient's anatomy instead of an image of the anatomical model) that simulates the view that the prop endoscope 220 would have if the anatomical model 202 were the anatomy of a real person. As a user manipulates the prop endoscope 220 relative to the anatomical model, the display 250 can display (e.g., as a video or still image) the anatomy of a real patient from the perspective of an endoscope relative to a patient.

FIGS. 3A and 3B illustrate additional example implementations of the present disclosure configured for endoscope training. The example system shown in FIG. 3A includes a display 350 with anatomy markers 352a, 352b on two parts of the simulated image 360. The anatomy markers 352a, 352b can be used to mark any portion(s) of a patient's anatomy. The user can be instructed (optionally using the display 350) to select a command or press a button to identify the anatomy marker 352a, 352b that corresponds to an anatomical feature (e.g., the user can be quizzed by identifying anatomies within the simulated image 360). Additionally, as also shown in FIG. 3A, the display 350 can output instructions 354 to the user to position the endoscope 320 in the anatomical model 302a that corresponds to a position in a real patient. FIG. 3A further illustrates an example endoscopic tip 322 where the color of the endoscopic tip is used as a marker to track the end of the endoscope (e.g., the color of the endoscopic tip acts as the instrument marker described in FIG. 1). A clear protector 303 is positioned over the anatomical model 302a and allows the position of the endoscope 320 and endoscopic tip 322 to be seen relative to the anatomical model. A simulated image 360 showing a real procedure from the point of view of the endoscopic tip 322 (e.g., as though the endoscopic tip was inside the actual patient anatomy instead of an anatomical model) is shown on the display 350.

With reference to FIG. 3B, an additional example system is shown for simulating endoscope procedures using a 3D printed anatomical model 302b of a cross section of a patient's anatomy. A camera 110 is positioned with a camera field of view 112 including the 3d-printed anatomical model 302b. The endoscopic tip 322, model tracker 304, and endoscope 320 described with reference to FIG. 3A are shown.

It should be understood that the examples shown in FIGS. 2A-3B that are configured for endoscope training/simulation are non-limiting examples, and that implementations of the present disclosure can be used for simulation/training using any type of instrument.

With reference to FIG. 4, implementations of the present disclosure include computer-implemented methods that can be performed by the controller 130 shown in FIG. 1. The computer implemented methods of FIG. 4 allow for realistic training to be performed by combining simulated images (i.e., images of real patient anatomy, referred to herein as images/videos of a “non-simulated procedure”) with simplified anatomical models, and thereby allow efficient training (in other words, during the training using the system/methods described herein, the simulated images are simulated from the point of view of the training, even though they are real images from a prior real procedure). While the method of FIG. 4 is described with reference to the system of FIG. 1, it should be understood that the method of FIG. 4 can be used with systems other than the system of FIG. 1, according to implementations of the present disclosure. In some implementations, the system of FIG. 1 and/or the method of FIG. 4 can be configured to provide training/instruction to a user, and/or provide feedback on the user's performance.

At step 410 the method includes receiving an image from the camera. As described with reference to FIGS. 1-3B, the image can include at least part of an anatomical model (e.g., a pharynx/larynx) and at least part of a real or simulated instrument (e.g., a model or real endoscope). Alternatively or additionally, the image can include markers used by a computer vision system to identify the location of the anatomical model and/or the instrument relative to each other. Any number of markers can be used on the anatomical model and/or the instrument.

At step 420 the method includes determining a position of the instrument relative to an anatomical model based on the image. Optionally step 420 can further include determining an orientation of the instrument 120 relative to the anatomical model 102, and/or determining a velocity/acceleration of the instrument 120 relative to the anatomical model 102.

At step 430 the method can include displaying a corresponding anatomical image from an imaging procedure based on the position of the instrument 120 relative to the anatomical model 102. The corresponding anatomical image simulates the view that a real instrument would have if positioned inside a real patient. As described with reference to FIG. 3A, step 430 can optionally include displaying an instruction to position the instrument at a predetermined location relative to the anatomical model. As used herein, the predetermined location can refer to a location that is configured to view and/or treat a part of a patient's anatomy. For example, as described above, implementations of the present disclosure can be used to train practitioners to perform endoscope examinations of swallowing (e.g., the FEES exam). Thus, as an example, implementations of the present disclosure can provide instructions to a user to position the instrument at positions (relative to the anatomical model) corresponding to positions in an actual patient during a FEES exam.

In some implementations, the method shown in FIG. 4 can optionally include detecting that the instrument is positioned at a predetermined location relative to the anatomical model. For example, if the display displays an instruction to position the instrument at a predetermined location, the method can include detecting that the instrument is positioned at the predetermined location.

Optionally, the method can include further steps based on detecting that the instrument is positioned at the predetermined location. For example, the method can include outputting to the user an indication that the instrument is positioned at a predetermined position. Alternatively or additionally, the method can include providing additional instructions to the user (e.g., to move to another location and/or identify a an anatomical structure at the predetermined location).

The steps described with reference to FIG. 4 can be repeated any number of times. For example, implementations of the present disclosure can include repeatedly or continuously determining the position of the instrument relative to an anatomical model, and displaying corresponding anatomical images if the position of the instrument relative to the anatomical model changes. Thus, the steps of FIG. 4 can be used to continuously display a simulated view of the anatomy of a patient as the instrument is moved relative to the anatomical model.

### Discussion

Implementations of the present disclosure can improve detection of dysphagia, endoscopic procedures, laparoscopic surgeries, gastroenterology, and/or any other procedures performed within otolaryngology.

For example, some implementations can improve training for examinations to detect dysphagia. Dysphagia affects approximately 9.4 million adults in the United States [7].Dysphagia is correlated with increased mortality rates and places a significant burden on the healthcare system [6]. Inpatients diagnosed with dysphagia cost a mean of $6,243 more than patients without dysphagia and are 33.2% more likely to be discharged to post-acute care facilities [6]. Dysphagia results in serious comorbidities including pneumonia, malnutrition, sepsis or feeding tube placement. Early intervention through diagnosis and treatment can prevent long-term sequela and improve patient outcomes [4]. Despite this, only approximately 19.2% of patients with swallowing problems report they have received treatment [7]. In order for a patient to receive dysphagia treatment, they generally receive an instrumental evaluation of swallowing. Two instrumental exams are generally used for swallowing assessment: the Videofluoroscopic Swallow Study (VFSS) and the Fiberoptic Endoscopic Evaluation of Swallowing (FEES). Instrumental exams can be the first step in initiating dysphagia services and can be important for accurate treatment selection. Unfortunately, access to instrumental exams can be limited due to costs of equipment and/or difficulty transporting patients. Unlike VFSS, which can require a radiology suite, FEES can be portable and/or cost-effective, having the potential to expand access to dysphagia care. Despite this, relatively few Speech Language Pathologists (SLP's) perform this exam due to lack of training [5].

Approximately 29% of practicing SLP's who treat dysphagia report confidence in their ability to conduct FEES exams [3]. The current state of FEES training for practicing clinicians consists of costly professional education courses that often do not provide sufficient experience for clinicians to meet local competency requirements. Within graduate level education, hands-on FEES training rarely occurs due to cost of equipment, lack of instructors, and/or other limitations. At the time of their graduation, 94% of SLP graduate students report feeling unprepared to perform FEES exams [3]. Thus, implementations of the present disclosure can include simulation as an effective method in medical education for providing skills practice that would be otherwise difficult or costly to obtain. Existing FEES simulations fail to capture all exam elements as defined by the American Speech-Language Hearing Association for determination of competency. The implementations of the present disclosure described herein can therefore enhance simulations using 3D models. The ADEPT simulation can also enable a integration of affordable and/or hands-on skills training for FEES into curriculums, including a comprehensive e-learning curriculum featuring any/all elements of the FEES exams for learning and competency assessment. In short, the implementations described herein can increase the number of clinicians who can access, afford, and/or receive hands-on FEES training and thereby have significant impacts on patient outcomes and healthcare associated costs of treatment for dysphagia.

It should be understood that the implementations of the present disclosure described herein can be used to implement various human-computer interface/interaction HCl systems, using different numbers and types of computing devices.

It should be appreciated that the logical operations described herein with respect to the various figures may be implemented (1) as a sequence of computer implemented acts or program modules (i.e., software) running on a computing device (e.g., the computing device described in FIG. 6), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 6, an example computing device 600 upon which the methods described herein may be implemented is illustrated. It should be understood that the example computing device 600 is only one example of a suitable computing environment upon which the methods described herein may be implemented. Optionally, the computing device 600 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 600 typically includes at least one processing unit 606 and system memory 604. Depending on the exact configuration and type of computing device, system memory 604 may be volatile (such as random access memory (RAM)), non-volatile (such as read-only memory (ROM), flash memory, etc.), or some combination of the two. This most basic configuration is illustrated in FIG. 6 by dashed line 602. The processing unit 606 may be a standard programmable processor that performs arithmetic and logic operations necessary for operation of the computing device 600. The computing device 600 may also include a bus or other communication mechanism for communicating information among various components of the computing device 600.

Computing device 600 may have additional features/functionality. For example, computing device 600 may include additional storage such as removable storage 608 and non-removable storage 610 including, but not limited to, magnetic or optical disks or tapes. Computing device 600 may also contain network connection(s) 616 that allow the device to communicate with other devices. Computing device 600 may also have input device(s) 614 such as a keyboard, mouse, touch screen, etc. Output device(s) 612 such as a display, speakers, printer, etc. may also be included. The additional devices may be connected to the bus in order to facilitate communication of data among the components of the computing device 600. All these devices are well known in the art and need not be discussed at length here.

The processing unit 606 may be configured to execute program code encoded in tangible, computer-readable media. Tangible, computer-readable media refers to any media that is capable of providing data that causes the computing device 600 (i.e., a machine) to operate in a particular fashion. Various computer-readable media may be utilized to provide instructions to the processing unit 606 for execution. Example tangible, computer-readable media may include, but is not limited to, volatile media, non-volatile media, removable media and non-removable media implemented in any method or technology for storage of information such as computer readable instructions, data structures, program modules or other data. System memory 604, removable storage 608, and non-removable storage 610 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 606 may execute program code stored in the system memory 604. For example, the bus may carry data to the system memory 604, from which the processing unit 606 receives and executes instructions. The data received by the system memory 604 may optionally be stored on the removable storage 608 or the non-removable storage 610 before or after execution by the processing unit 606.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### References

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entireties and to the same extent as if each reference was individually incorporated by reference.
[1] Adkins, C., Takakura, W., Spiegel, B. M. R., Lu, M., Vera-Llonch, M., Williams, J., & Almario, C. V. (2020). Prevalence and Characteristics of Dysphagia Based on a Population-Based Survey. Clinical Gastroenterology and Hepatology, 18(9), 1970-1979.e2. https://doi.org/10.1016/j.cgh.2019.10.029
[2] Brown, T., Cosgriff, T., & French, G. (2008). Learning Style Preferences of Occupational Therapy, Physiotherapy and Speech Pathology Students: A Comparative Study. Internet Journal of Allied Health Sciences and Practice, 6(3). https://doi.org/10.46743/640-580X/2008.1204
[3] Caesar, L. G., & Kitila, M. (2020). Speech-Language Pathologists' Perceptions of Their Preparation and Confidence for Providing Dysphagia Services. Perspectives of the ASHA Special Interest Groups, 5(6), 1666-1682. https://doi.org/10.1044/2020_PERSP-20-00115
[4] Dziewas, R., auf dem Brinke, M., Birkmann, U., Bräuer, G., Busch, K., Cerra, F., Damm-Lunau, R., Dunkel, J., Fellgiebel, A., Garms, E., Glahn, J., Hagen, S., Held, S., Helfer, C., Hiller, M., Horn-Schenk, C., Kley, C., Lange, N., Lapa, S., . . . Warnecke, T. (2019). Safety and clinical impact of FEES—results of the FEES-registry. Neurological Research and Practice, 1(1), 16. https://doi.org/10.1186/s42466-019-0021-5
[5] Howells, S. R., Cornwell, P. L., Ward, E. C., & Kuipers, P. (2019). Understanding Dysphagia Care in the Community Setting. Dysphagia, 34(5), 681-691. https://doi.org/10.1007/s00455-018-09971-8
[6] Patel, D. A., Krishnaswami, S., Steger, E., Conover, E., Vaezi, M. F., Ciucci, M. R., & Francis, D. O. (2018). Economic and survival burden of dysphagia among inpatients in the United States. Diseases of the Esophagus, 31(1). https://doi.org/10.1093/dote/dox131
[7] Zheng, M., Zhou, S., Hur, K., Chambers, T., O'Dell, K., & Johns, M. (2023). Disparities in the prevalence of self-reported dysphagia and treatment among U.S. adults. American Journal of Otolaryngology, 44(2), 103774. https://doi.org/10.1016/j.amjoto.2022.103774

What is claimed:

1. A system comprising:
an anatomical model;
a camera configured to image the anatomical model;
an instrument; and
a controller operably coupled to the camera and the instrument, the controller comprising a processor and a memory, the memory having computer-executable instructions stored thereon that, when executed by the processor, cause the controller to:
receive an image from the camera;
determine, based on the image, a position of the instrument relative to the anatomic model; and
display a simulated image of an anatomical structure based on the position of the instrument relative to the anatomical model.

2. The system of claim 1, wherein the anatomical model comprises a marker, and wherein determining the position of the imaging instrument comprises determining the position of the imaging instrument relative to the marker.

3. The system of claim 2, wherein the marker comprises a binary identifier.

4. The system of claim 1, wherein the anatomic model comprises a model of an esophagus.

5. The system of claim 1, wherein the instrument comprises an endoscope.

6. The system of claim 1, wherein the instrument comprises a model of a laparoscopic instrument.

7. The system of claim 1, wherein the instrument comprises a model of an endoscope.

8. The system of claim 1, wherein the instrument comprises an instrument marker.

9. The system of claim 1, wherein the memory has further computer-executable instructions stored thereon that, when executed by the processor, cause the controller to: determine an orientation of the instrument relative to the anatomic model, and wherein the simulated image of the anatomical structure is based on the position and orientation of the instrument relative to the anatomical model.

10. The system of claim 1, wherein displaying a simulated image of an anatomical structure comprises displaying a frame of a video of a non-simulated procedure.

11. The system of claim 10, wherein the video of the non-simulated procedure comprises a plurality of frames, and wherein each of the plurality of frames is annotated with a position of the frame in the non-simulated procedure.

12. The system of claim 1 wherein the memory has further computer-executable instructions stored thereon that, when executed by the processor, cause the controller to: display an instruction to position the instrument at a predetermined location relative to the anatomical model.

13. The system of claim 12 wherein the memory has further computer-executable instructions stored thereon that, when executed by the processor, cause the controller to: detect that the instrument is positioned at the predetermined location of the anatomical model.

14. The system of claim 13, further comprising: displaying an indication that the instrument is positioned at the predetermined location of the anatomical model.

15. A computer-implemented method of simulating a procedure, comprising:
receiving an image from a camera;
determining a position of an instrument relative to an anatomical model based on the image; and
displaying a corresponding anatomical image from an imaging procedure based on the position of the instrument relative to the anatomical model.

16. The computer-implemented method of claim 15, wherein displaying the corresponding anatomical image from the imaging procedure comprises:
receiving a plurality of annotated images from the imaging procedure; and
selecting, from the plurality of annotated images, an image corresponding to a patient anatomy at the position of the instrument in the anatomical model.

17. The computer-implemented method of claim 16, further comprising: displaying an instruction to position the instrument at a predetermined location relative to the anatomical model.

18. The computer-implemented method of claim 17, further comprising: detecting that the instrument is positioned at the predetermined location of the anatomical model.

19. The computer-implemented method of claim 18, further comprising: displaying an indication that the instrument is positioned at the predetermined location of the anatomical model.

20. The computer-implemented method of claim 15, further comprising determining a velocity of the instrument relative to the anatomical model, and wherein displaying the corresponding anatomical image from the imaging procedure is based on both the position and velocity of the instrument relative to the anatomical model.
